(19) United States
(12) Patent Application Publication
(10) Pub. No.: US 2024/0320783 A1
(43) Pub. Date: Sep. 26, 2024

(54) BIASING CACHE REPLACEMENT FOR OPTIMIZED GRAPHICS PROCESSING UNIT (GPU) PERFORMANCE

(71) Applicant: QUALCOMM Incorporated, San Diego, CA (US)

(72) Inventor: Suryanarayana Murthy DURBHAKULA, Hyderabad (IN)

(21) Appl. No.: 18/189,146

(22) Filed: Mar. 23, 2023

(51) Int. Cl. G06T 1/60; G06T 1/20

(52) U.S. Cl. CPC G06T 1/60; G06T 1/20

(57) ABSTRACT

Aspects presented herein relate to methods and devices for graphics processing including an apparatus, e.g., a graphics processing unit (GPU). The apparatus may perform a replacement for at least one first cache line in a first cache. The apparatus may also detect that the at least one first cache line is present in a second cache. Further, the apparatus may adjust, based on the at least one first cache line being present in the second cache, an order of a set of first cache lines in the second cache, where the at least one first cache line is in the set of first cache lines in the second cache. The apparatus may also output an indication of the adjusted order of the set of first cache lines in the second cache. In another aspect, in multi-GPU systems, first cache may bias remote GPU lines giving them higher priority in replacement.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform graphics processing. The apparatus may perform a replacement for at least one first cache line in a first cache. The apparatus may also detect that the at least one first cache line is present in a second cache. Additionally, the apparatus may output, to the second cache, a second indication that the at least one first cache line is present in the second cache based on the detection that the at least one first cache line is present in the second cache. The apparatus may also adjust, based on the at least one first cache line being present in the second cache, an order of a set of first cache lines in the second cache, where the at least one first cache line is included in the set of first cache lines in the second cache. The apparatus may also move the at least one first cache line to a top of a least recently used (LRU) stack based on the at least one first cache line reaching the bottom of the LRU stack. The apparatus may also output an indication of the adjusted order of the set of first cache lines in the second cache based on the at least one first cache line being present in the second cache. In another example, the apparatus may set a value of at least one first bit for the at least one first cache line. The apparatus may also reset the value of the at least one first bit for the at least one first cache line when the at least one first cache line reaches a point of replacement in the first cache.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system.

FIG. 2 illustrates an example graphics processing unit (GPU).

FIG. 3 is a diagram illustrating example processing components.

FIG. 4 is a diagram illustrating an example GPU.

FIG. 5 is a diagram illustrating an example GPU.

FIG. 6 is a diagram illustrating an example mapping of a cache.

FIG. 7 is a diagram illustrating an example cache line replacement.

FIG. 8 is a diagram illustrating an example cache line replacement for multiple GPUs.

FIG. 9 is a diagram illustrating an example cache line replacement for a first cache and a second cache.

FIG. 10 is a communication flow diagram illustrating example communications between a GPU, a CPU, and a memory.

FIG. 11 is a flowchart of an example method of graphics processing.

FIG. 12 is a flowchart of an example method of graphics processing.

FIG. 13 is a communication flow diagram illustrating example communications between a GPU, a CPU, and a memory.

FIG. 14 is a flowchart of an example method of graphics processing.

### DETAILED DESCRIPTION

Different types of caches may include different levels and organization structures. Multiple level (multi-level) caches may be designed according to whether the content of a cache in one level of the multi-level cache is present in the other levels of caches. A cache replacement policy is an optimization that a GPU or CPU can utilize in order to manage a cache including data stored on the GPU or CPU. Cache replacement may improve performance of the GPU or CPU by keeping recent or often-used data in conveniently-accessed memory locations (e.g., memory locations that are faster or cheaper to access than normal memory storage). In some instances, when the cache is full, the cache replacement may select which data to discard in order to make room for new data. In some aspects, when replacing a particular cache line, a cache replacement policy may not consider the cost of fetching that cache line if it may be needed again in the near future. That is, in some instances, it may be beneficial to replace a cache line which may not be needed in the near future and has a reduced cost of fetching that cache line if it may be needed again. This may apply to different levels of caches (e.g., a level 1 (L1) cache, a level 2 (L2) cache, and/or a level 3 (L3) cache). In some types of caches (e.g., non-fully inclusive caches), if a cache line gets replaced from a lower-level cache (e.g., a larger and slower cache), the same cache line may exist in a higher-level cache (e.g., a smaller and faster cache). In some instances, if the cache line later gets replaced from the higher-level cache, the next time the cache line is needed, the GPU may be forced to retrieve the cache line from an inconvenient memory location (e.g., a dynamic random access memory (DRAM)). This may lead to a longer memory latency for the cache. Additionally, replacing cache lines which have a high cost of re-fetching may impact GPU performance if those cache lines are needed again. Aspects of the present disclosure may detect whether certain cache lines are included in different levels of caches. That is, aspects presented herein may determine if a certain cache line is present in different levels of caches at a GPU or CPU. For instance, when a cache line in lower-level cache (e.g., a larger cache) is replaced, aspects presented herein may determine if that same line exists in higher-level caches (e.g., faster caches). If a certain cache line is present in a higher-level cache, the GPU or CPU may move such cache lines to the top of a cache line stack (e.g., a least recently used (LRU) stack). By doing so, aspects presented herein may create a bias, as replacing such lines may mean bringing those lines again into the cache, which may entail a larger latency because that line is no longer in the lower-level cache.

Aspects presented herein may include a number of benefits or advantages. Aspects presented herein may improve memory performance and/or average memory latency for caches in GPUs and CPUs. For instance, aspects of the present disclosure may detect whether certain cache lines are included in different levels of caches. For example, when a cache line in lower-level cache (e.g., a larger cache) is replaced, aspects presented herein may determine if that same line exists in higher-level caches (e.g., faster caches). If a certain cache line is present in a higher-level cache, the GPU or CPU may move such cache lines to the top of a cache line stack (e.g., a least recently used (LRU) stack. By doing so, aspects presented herein may create a bias, as replacing such lines may mean bringing those lines again into the cache, which would entail a larger latency because that line is no longer in the lower-level cache. That is, aspects of the present disclosure may improve memory performance and/or average memory latency for caches in GPUs and CPUs. Moreover, aspects presented herein may determine which cache lines have a high re-fetch cost, as well as keep track of an entire a cache replacement policy. Aspects presented herein also identify whether certain cache lines are included in different levels of caches.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

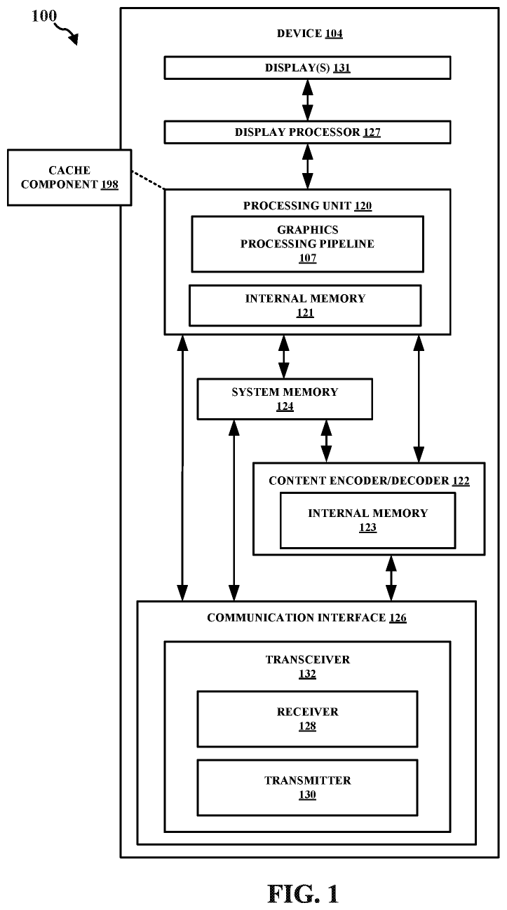

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a cache component 198 configured to perform a replacement for at least one first cache line in a first cache. The cache component 198 may also be configured to detect that the at least one first cache line is present in a second cache. The cache component 198 may also be configured to output, to the second cache, a second indication that the at least one first cache line is present in the second cache based on the detection that the at least one first cache line is present in the second cache. The cache component 198 may also be configured to adjust, based on the at least one first cache line being present in the second cache, an order of a set of first cache lines in the second cache, where the at least one first cache line is included in the set of first cache lines in the second cache. The cache component 198 may also be configured to move the at least one first cache line to a top of a least recently used (LRU) stack based on the at least one first cache line reaching the bottom of the LRU stack. The cache component 198 may also be configured to output an indication of the adjusted order of the set of first cache lines in the second cache based on the at least one first cache line being present in the second cache. In another example, the cache component 198 may also be configured to set a value of at least one first bit for the at least one first cache line. The cache component 198 may also be configured to reset the value of the at least one first bit for the at least one first cache line when the at least one first cache line reaches a point of replacement in the first cache. Although the following description may be focused on display processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

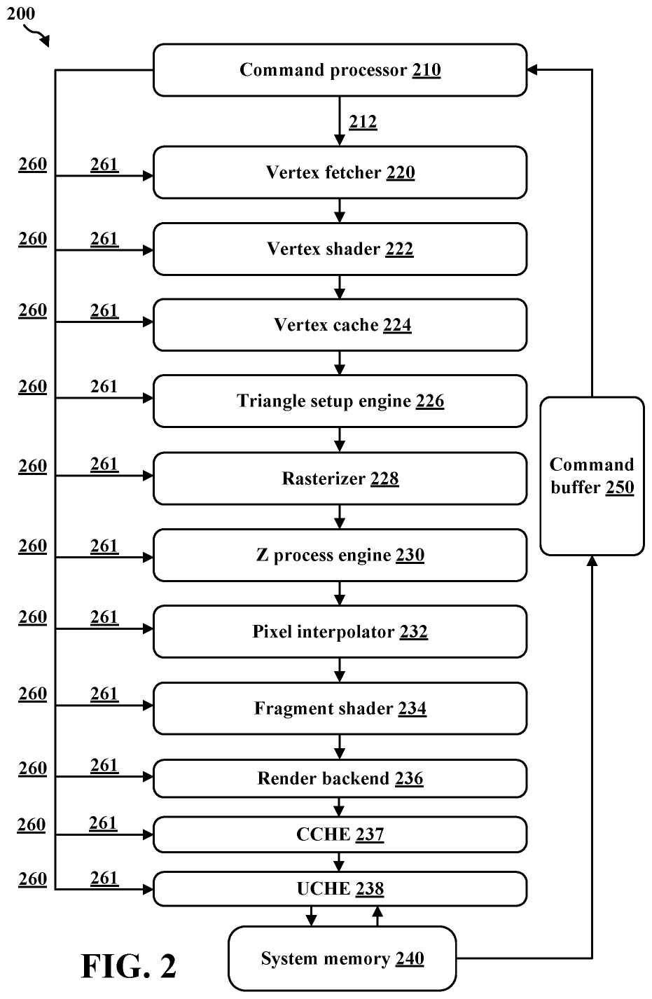

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

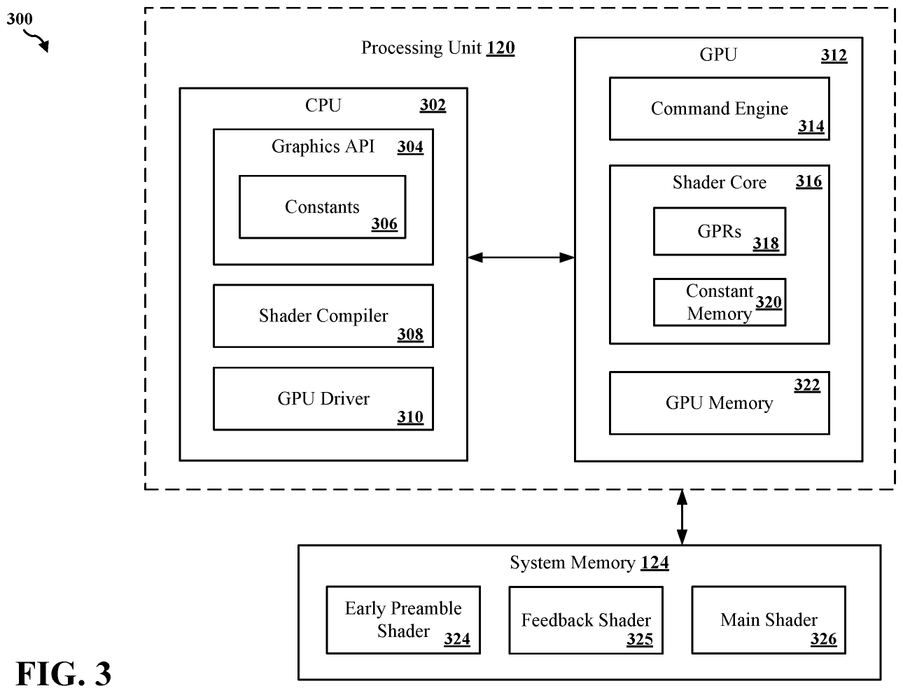

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

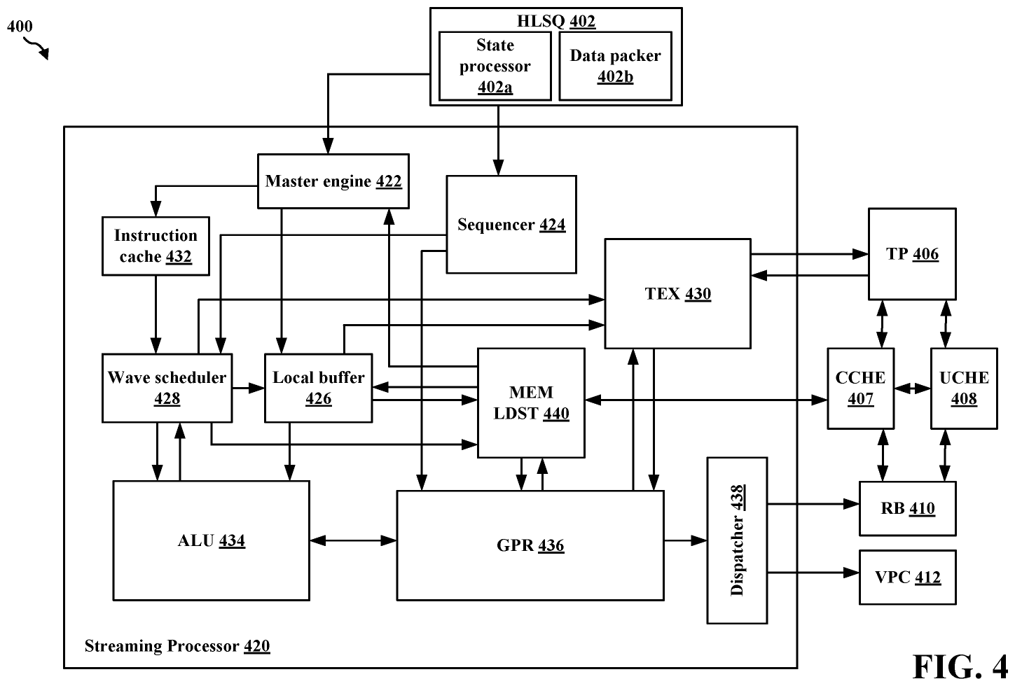

FIG. 4 illustrates an example GPU 400. Specifically, FIG. 4 illustrates a streaming processor (SP) system in GPU 400. As shown in FIG. 4, GPU 400 includes a high level sequencer (HLSQ) 402, texture processor (TP) 406, level 1 (L1) cache (cluster cache (CCHE)) 407, level 2 (L2) cache (UCHE) 408, render backend (RB) 410, and vertex cache (VPC) 412. GPU 400 also includes SP 420, master engine 422, sequencer 424, local buffer 426, wave scheduler 428, texture (TEX) 430, instruction cache 432, arithmetic logic unit (ALU) 434, GPR 436, dispatcher 438, and memory (MEM) load store (LDST) 440.

As shown in FIG. 4, each unit or block in GPU 400 may send data or information to other blocks. For instance, HLSQ 402 may send commands to the master engine 422. Also, HLSQ 402 may send vertex threads, vertex attributes, pixel threads, pixel attributes, and/or compute commands to the sequencer 424. TP 406 may receive texture requests from TEX 430, and send texture elements (texels) back to the TEX 430. Further, TP 406 may send memory read requests to and receive memory data from CCHE 407 or UCHE 408. CCHE 407 or UCHE 408 may also receive memory read or write requests from MEM LDST 440 and send memory data back to MEM LDST 440, as well as receive memory read or write requests from RB 410 and send memory data back to RB 410. Also, RB 410 may receive an output in the form of color from GPR 436, e.g., via dispatcher 438. VPC 412 may also receive output in the form of vertices from GPR 436, e.g., via dispatcher 438. GPR 436 may send address data or receive write back data from MEM LDST 440. GPR 436 may also send temporary data to and receive temporary data from ALU 434. Moreover, ALU 434 may send address or predicate information to the wave scheduler 428, as well as receive instructions from wave scheduler 428. Local buffer 426 may send constant data to ALU 434. TEX 430 may also receive texture attributes from or send texture data to GPR 436, as well as receive constant data from local buffer 426. Further, TEX 430 may receive texture requests from wave scheduler 428, as well as receive constant data from local buffer 426. MEM LDST 440 may send/receive constant data to/from local buffer 426. Sequencer 424 may send wave data to wave scheduler 428, as well as send data to GPR 436. The sequencer 424 may allocate resources and local memory. Also, the sequencer 424 may allocate wave slots and any associated GPR 436 space. For example, the sequencer 424 may allocate wave slots or GPR 436 space when the HLSQ 402 issues a pixel tile workload to the SP 420. Master engine 422 may send program data to instruction cache 432, as well as send constant data to local buffer 426 and receive instructions from MEM LDST 440. Instruction cache 432 may send instructions or decode information to wave scheduler 428. Wave scheduler 428 may send read requests to local buffer 426, as well as send memory requests to MEM LDST 440.

As further shown in FIG. 4, the HLSQ 402 may prepare one or more context states for the SP 420. For example, the HLSQ 402 may prepare the context states for different types of data, e.g., global register data, shader constant data, buffer descriptors, instructions, etc. Additionally, the HLSQ 402 may embed context states into a command stream to the SP 420. The master engine 422 may parse the command stream from the HLSQ 402 and setup an SP global state. Moreover, the master engine 422 may fill or add to an instruction cache 432 and/or a local buffer 426 or a constant buffer. In some aspects, inside the HLSQ 402, there may be an internal function unit called a state processor 402a. The state processor 402a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 402 may execute the preamble shader and, as a result, skip utilizing a main shader. In some instances, the main shader may perform different shading tasks, such as normal vertex shading and/or a fragment shading program. Moreover, the HLSQ 402 may include a data packer 402b.

Additionally, as shown in FIG. 4, the SP 420 may not be limited to executing a preamble if the HLSQ 402 decides to skip a preamble execution. For instance, the SP 420 may also process a conventional graphics workload, such as vertex shading and/or fragment shading. In some aspects, the SP 420 may utilize its execution units and storage in order to process compute tasks as a general purpose GPU (GPGPU). Inside the SP 420, there may be multiple parallel instruction execution units such as an ALU, elementary function unit (EFU), branching unit, TEX, general memory read and write (aka LDST), etc. The SP 420 may also include on-chip storage memory, such as a GPR 436 which may store per-fiber private data. Also, the SP 420 may include a local buffer 426 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 4, dispatcher 438 may fetch data from GPR 436. Dispatcher 438 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

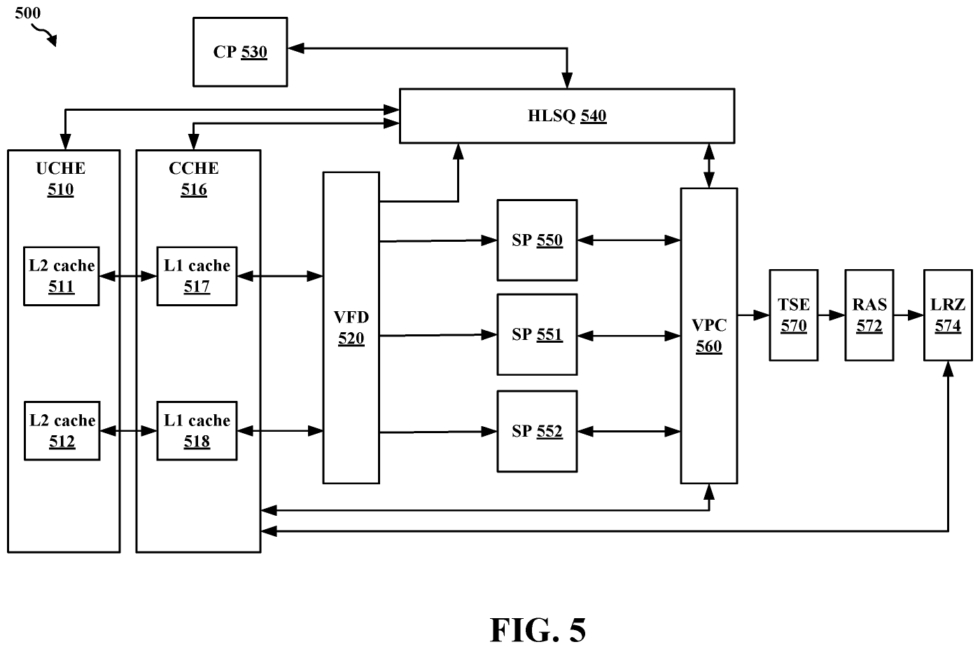

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of SPs (e.g., SP 550, SP 551, and SP 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to SPs 550-552. Moreover, SPs 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

As depicted in FIG. 5, GPUs (e.g., GPU 500) may include a number of different caches. GPUs utilize caches for a variety of reasons, such as to transfer data at a sufficiently high rate of speed. That is, as processing power for GPUs has increased at a higher rate than memory access speed, storage resources (e.g., caches) between the processor and memory have been utilized to transfer data at a sufficient rate. Caches at GPUs are also utilized to more seamlessly transfer data. One benefit of caches is that they provide buffering, so caches and buffers may be similar. For instance, caches may decrease latency by reading data from memory in larger chunks based on subsequent data accessing nearby address locations. Also, caches may increase throughput by assembling multiple small transfers into larger, more efficient memory requests. These benefits may be achieved by a cache storing data in blocks called cache lines. A cache line may be a portion of data that can be mapped into a cache. For example, a cache line may be a smallest portion of data that can be mapped into a cache.

In some aspects, each mapped cache line may be associated with a block (e.g., a core line), which is a corresponding region on a main memory or a backend storage). A backend storage may allow performance for the cache and GPU to improve. For example, database caching may allow an increased throughput and a reduced data retrieval latency associated with backend databases, which may improve the overall performance of the cache and GPU. Also, in some aspects, both the cache and main memory/backend storage may be divided into blocks of the size of a cache line. Further, all the cache mappings may be aligned to these blocks. Cache lines may have a certain size (e.g., between 32 to 512 bytes), and memory transactions may be performed in units of cache lines. Individual cache accesses made by code that executes on a GPU processor may be smaller than these units of cache lines (e.g., 4 bytes).

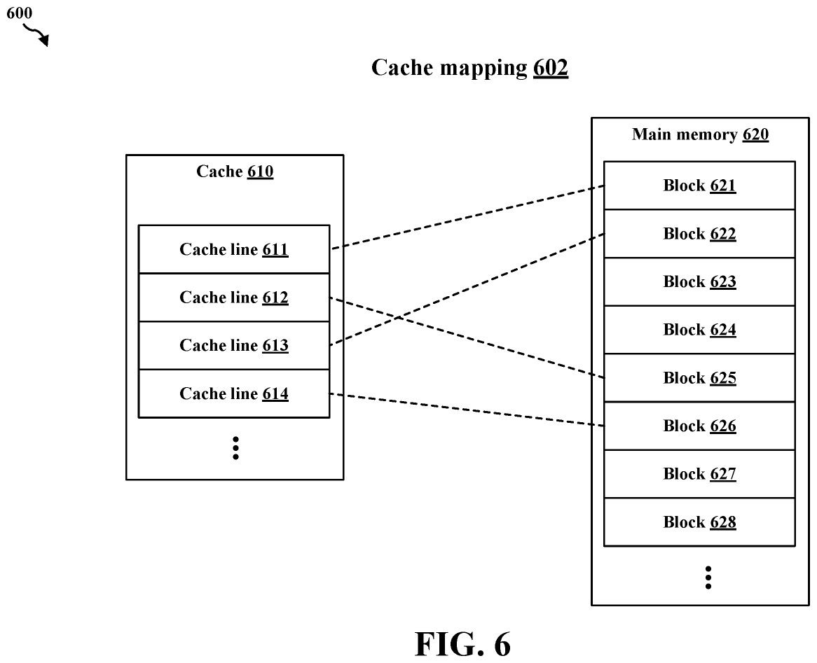

FIG. 6 is a diagram 600 illustrating an example mapping of a cache. More specifically, FIG. 6 depicts a cache mapping 602 for a cache 610 and a main memory 620. That is, FIG. 6 depicts the relationship between cache lines in cache 610 (e.g., cache line 611, cache line 612, cache line 613, and cache line 614) and blocks in main memory 620 (e.g., block 621, block 622, block 623, block 624, block 625, block 626, block 627, and block 628). As shown in FIG. 6, diagram 600 illustrates that individual blocks 621-628 may be directly mapped to individual cache lines 611-614. For example, as illustrated in diagram 600, block 621 may be mapped to cache line 611, block 622 may be mapped to cache line 613, block 625 may be mapped to cache line 612, and block 626 may be mapped to cache line 614. Some of the blocks 621-628 may not be directly mapped to cache lines 611-614. For instance, block 623, block 624, block 627, and block 628 may not be directly mapped to cache lines 611-614. In some aspects, main memory 620 including blocks 621-628 may be a backend storage including a number of core lines.

Valid data (e.g., valid bits) and dirty data (e.g., dirty bits) may correspond to a current cache line state. For instance, when a cache line is valid (i.e., in a valid state) it may refer to the cache line being mapped to a block in main memory (e.g., a core line determined by a core identifier (ID) and a core line number). When a cache line is invalid (i.e., in an invalid state), it may be used to map a core line accessed by a certain request (e.g., an input/output (I/O) request), and the cache line may become valid thereafter. A cache line may return to an invalid state based on a number of different reasons. For example, a cache line may return to an invalid state: if the cache line is being evicted, if the core pointed to by the core ID is being removed, if the core pointed to by the core ID is being purged, if the entire cache is being purged, during a discard operation being performed on a corresponding core line, or during a certain request (e.g., an I/O request) when a cache mode which may perform an invalidation is selected.

In some aspects, dirty data or modified data may refer to data that is associated with a block of memory and indicates whether the corresponding block of memory has been modified. For example, a dirty bit or modified bit may be a bit that is associated with a block of memory and indicates whether the corresponding block of memory has been modified. The dirty data (e.g., dirty bit) may be set when a processor writes to (i.e., modifies) this memory. For instance, the dirty data (e.g., dirty bit) may indicate that its associated block of memory has been modified and has not been saved to storage yet. That is, “dirty data” may refer to data in a cache that is modified, but the memory still has an old or stale copy of the data. In some instances, when a block of memory is to be replaced, its corresponding dirty data (e.g., dirty bit) may be checked to determine if the block may need to be written back to secondary memory before being replaced or if it can simply be removed. Moreover, dirty data (e.g., dirty bit) may determine if the cache line data stored in the cache is in synchronization with corresponding data on the backend storage. For instance, if a cache line is dirty, then data on the cache storage may be up to date, and the data may need to be flushed (i.e., removed) at some point in the future (e.g., after the flushing the data may be marked as clean by zeroing a dirty bit). Also, a cache line may be considered valid if at least one of its sectors is valid. Likewise, a cache line may be considered dirty if at least one of its sectors is dirty.

In some instances, a goal of caches in GPUs may be to increase the performance of repeated accesses to the same data, as caches may keep a copy of a subset of the data in memory. Accordingly, subsequent accesses of the data already in the cache may not utilize an expensive memory access transaction. As some caches may have a smaller capacity than the memory size of the GPU system, the currently-cached data set may continuously change. This continuously change in cached data may be due to the memory access pattern of the executed code and/or the data replacement policy of the cache. In some aspects, one goal of caches may be to maximize the cache hit rate (i.e., the percentage of data accesses that can be served from data in the cache). By maximizing the cache hit rate, the overall performance of the GPU may be increased. This performance improvement may be important for GPUs, as GPUs may serve numerous simultaneously running threads with data.

Caches may receive a number of requests (e.g., data or content requests) to store or cache data. A cache hit may refer to an event when data requested for processing (e.g., requested by a component or application) is successfully retrieved from the cache memory. For example, a cache hit may describe when data or content is successfully found in the cache. That is, a cache hit may be when a system or application makes a request to retrieve data from a cache, and the specific data is currently in cache memory. A cache miss may refer to an event when data requested for processing (e.g., requested by a component or application) is not successfully retrieved from the cache memory. For example, a cache miss may describe when data or content is not successfully found in the cache. That is, a cache miss may be when a system or application makes a request to retrieve data from a cache, but that specific data is not currently in cache memory. Caches may be measured based on an amount of data requests that the cache is able to successfully fill. A cache hit rate (i.e., hit rate or cache hit ratio) is a measurement of how many data requests a cache is able to successfully fill compared to a total number of data requests it receives. For instance, a cache hit rate (i.e., hit rate or cache hit ratio) is equal to the number of cache hits divided by the total number of data requests. As a formula, cache hit rate=(number of cache hits)/(number of cache hits+number of cache misses).

There are a number of different types of caches that are utilized by GPUs. For instance, there are fully-associative caches, direct-mapped caches, and set-associative cache. A fully-associative cache may utilize a least recently used (LRU) cache policy, where there are a number of cells (e.g., M cells) that are each capable of holding a cache line corresponding to any of the memory locations (e.g., N memory locations). In the case of cache contention, the cache line that is not accessed the longest may be kicked out and replaced with a new cache line. A direct-mapped cache may directly map a block of memory to a single cache line which it can occupy. A set-associative cache may divide the address space into equal groups, which separately act as small fully-associative caches.

An associativity of a cache may refer to the size of the cache sets, or, i.e., how many different cache lines each data block can be mapped to. That is, the associativity of a cache may refer to a number of cache lines that are associated with a cache set for the cache. A cache set may include the number of cache lines in the cache. A higher associativity may result in a more efficient utilization of a cache, but may also increase the power/cost utilized by the cache. Likewise, a lower associativity may decrease the power/cost utilized by the cache, but may result in a less efficient utilization of the cache. The capacity of a cache may refer to the amount of data or information that can be stored in the cache. Additionally, the capacity or associativity of the cache may be adjusted based on a number of different factors of the GPU (e.g., a cache hit rate).

As indicated herein, caches may read certain data from memory based on subsequent data accessing nearby cache address locations. In some instances, caches may increase throughput by moving smaller data transfers into larger (i.e., more efficient) memory requests. That is, a cache may store data in blocks called cache lines, where a cache line is a portion of data that can be mapped into a cache. For instance, a cache line may be the smallest portion of data that can be mapped into a cache. In some instances, each mapped cache line may be associated with a block (e.g., a core line), which is a corresponding region on a main memory or a backend storage. Further, in some aspects, both the cache and main memory/backend storage may be divided into blocks of the size of a cache line. Moreover, in some aspects, all the cache mappings may be aligned to these blocks. Cache lines may correspond to a certain size (e.g., between 32 to 512 bytes), and memory transactions may be performed in units of the cache lines. In some aspects, individual cache accesses made via code that executes on a GPU processor may be smaller than these units of cache lines (e.g., 4 bytes).

Different types of caches may include different levels and organization structures. Multiple level (multi-level) caches may be designed according to whether the content of a cache in one level of the multi-level cache is present in the other levels of caches. For instance, if all blocks in a higher-level cache are also present in a lower-level cache in the multi-level cache, the lower-level cache is inclusive of the higher-level cache. Likewise, if the lower-level cache contains solely blocks that are not present in the higher-level cache, the lower-level cache is exclusive of the higher-level cache. Additionally, if the contents of the lower-level cache are neither inclusive nor exclusive of the higher-level cache, the lower-level cache is referred to as a non-inclusive non-exclusive (NINE) cache. In an inclusive cache policy, if there is a cache miss, other similar caches may be checked for the block. For example, if a lower-level cache is inclusive of a higher-level cache, and there is a cache miss in the lower-level cache, the higher-level cache may not need to be searched. Also, in an inclusive cache policy, the unique memory capacity of the cache may be determined by the lower-level cache. This is in contrast to exclusive caches, where the unique memory capacity is the combined capacity of all caches in the cache hierarchy. For instance, if the size of a lower-level cache is small and comparable with the size of a higher-level cache, inclusive caches may waste a larger amount of cache capacity compared to exclusive caches.

A cache replacement policy is an optimization that a GPU or CPU can utilize in order to manage a cache including data stored on the GPU or CPU. Cache replacement may improve performance of the GPU or CPU by keeping recent or often-used data in conveniently-accessed memory locations (e.g., memory locations that are faster or cheaper to access than normal memory storage). In some instances, when the cache is full, the cache replacement may select which data to discard in order to make room for new data. In some aspects, cache replacement may be utilized with associative and set associative techniques. Cache line replacement may refer to the replacement of cache lines within a cache. There may be a number of different cache replacement policies. For example, a least recently used (LRU) cache replacement may replace the cache line that has been in the cache the longest with no references to the particular cache line. A first-in first-out (FIFO) cache replacement may replace the cache line that has been in the cache the longest. Also, a least frequently used (LFU) cache replacement may replace the cache line that has experienced the fewest references. Further, a random cache replacement may select a cache line at random from the candidate cache lines in the cache.

In some aspects, when replacing a particular cache line, a cache replacement policy may not consider the cost of fetching that cache line if it may be needed again in the near future. That is, in some instances, it may be beneficial to replace a cache line which may not be needed in the near future and has a reduced cost of fetching that cache line if it may be needed again. This may apply to different levels of caches (e.g., a level 1 (L1) cache, a level 2 (L2) cache, and/or a level 3 (L3) cache). In some types of caches (e.g., non-fully inclusive caches), if a cache line gets replaced from a lower-level cache (e.g., a larger and slower cache), the same cache line may exist in a higher-level cache (e.g., a smaller and faster cache). In some instances, if the cache line later gets replaced from the higher-level cache, the next time the cache line is needed, the GPU may be forced to retrieve the cache line from an inconvenient memory location (e.g., a dynamic random access memory (DRAM)). This may lead to a longer memory latency for the cache. Additionally, replacing cache lines which have a high cost of re-fetching may impact GPU performance if those cache lines are needed again. Based on the above, it may be beneficial to keep track of the re-fetch cost of cache lines, along with an entire a cache replacement policy. For instance, it may be beneficial to determine which cache lines include a high re-fetch cost. It may also be beneficial to identify whether certain cache lines are included in different levels of caches.

Aspects of the present disclosure may detect whether certain cache lines are included in different levels of caches. That is, aspects presented herein may determine if a certain cache line is present in different levels of caches at a GPU or CPU. For instance, when a cache line in lower-level cache (e.g., a larger cache) is replaced, aspects presented herein may determine if that same line exists in higher-level caches (e.g., faster caches). If a certain cache line is present in a higher-level cache, the GPU or CPU may move such cache lines to the top of a cache line stack (e.g., a least recently used (LRU) stack). By doing so, aspects presented herein may create a bias, as replacing such lines may mean bringing those lines again into the cache, which may entail a larger latency because that line is no longer in the lower-level cache. That is, aspects of the present disclosure may improve memory performance and/or average memory latency for caches in GPUs and CPUs. In some instances, aspects presented herein (e.g., GPUs and CPUs) may detect that a cache line is present in a higher-level cache. After doing so, aspects presented herein (e.g., GPUs and CPUs) may adjust an order of cache lines in the higher-level cache, where the cache line is included in the higher-level cache. Moreover, aspects presented herein may determine which cache lines have a high re-fetch cost, as well as keep track of an entire a cache replacement policy. Aspects presented herein also identify whether certain cache lines are included in different levels of caches.

In some instances, aspects presented herein may keep track of cache lines and bias the cache replacement policy in order to give a second chance to such cache lines. That is, while replacing lines in a cache apart from the original replacement policy (e.g., an LRU cache replacement policy), aspects presented herein may take into consideration if a certain cache line is replaced, how much memory latency may be incurred in order to retrieve the cache line. And if the corresponding memory latency is large, then the replacement policy may be biased for such cache lines and in order to provide these lines a second chance. Aspects presented herein may also be applied to multi-GPU or multi-CPU systems, where cache lines are stored in a local cache, which may have been retrieved from a remote cache located in another GPU in a multi-GPU system. In these cases, while replacing such cache lines from the local cache, it may be advantageous to determine the replacement location of the cache line, as well as how much memory latency would be incurred if the same cache line were fetched from a local cache. After this determination, aspects presented herein may bias a cache replacement accordingly.

In one example, if a cache line is being replaced from a second cache (e.g., L2 cache), aspects presented herein (e.g., a GPU or CPU) may send a request to a first cache (e.g., L1 cache) for that same cache line. Also, the GPU may ignore if any request sent to the first cache (e.g., L1 cache) comes back with the data. Also, the GPU may not consume that data from the first cache (e.g., L1 cache). Rather, the GPU may take advantage of the side effect of the cache hit, which is that if the line is moved to the top of a least recently used (LRU) stack, that particular line may not be replaced in the near future. Accordingly, the GPU may take advantage of the line being moved to the top the LRU stack due to the cache hit, such that the line may not be replaced in the near future.

As mentioned herein, aspects presented here may include a biasing cache replacement policy. In some instances, caches in a GPU may not be fully inclusive (i.e., a cache is inclusive if a line in a higher-level cache (e.g., a smaller cache) is included in a lower-level cache (e.g., a larger cache). At a first step in a cache replacement, if a cache line is replaced in a lower-level cache (e.g., a larger cache), a GPU may determine if the same cache line exists in all higher-level caches (e.g., faster caches). If the cache line exists in the higher-level caches, the GPU may move the cache line to top of a least recently used (LRU) stack. By doing so, aspects presented herein may create bias in the cache replacement policy. For instance, replacing such lines may mean bringing those lines again into the cache, which may entail a larger memory latency, as that line is no longer in the lower-level cache. At a second step in a cache replacement, aspects presented herein may adjust an order of the cache lines in the higher-level cache (e.g., faster cache). That is, since the replacement policy has been biased, aspects presented herein may reduce the possibility of replacing cache lines with a higher re-fetch cost. By doing so, this may potentially reduce memory latency and/or improve overall GPU performance.

In some aspects, for remote cache lines, aspects presented herein may detect that an additional one-bit per cache line may be needed (e.g., in a local cache). For example, at install time, aspects presented herein may set this bit just for remote cache lines. Once a cache line reaches the bottom of an LRU stack, aspects presented herein may determine if the bit is set. If the bit is already set, then the GPU may reset the bit. Also, once the bit is reset, it may be moved to the top of the LRU stack. By doing so, this may give the bit a second chance and thus bias the replacement policy.

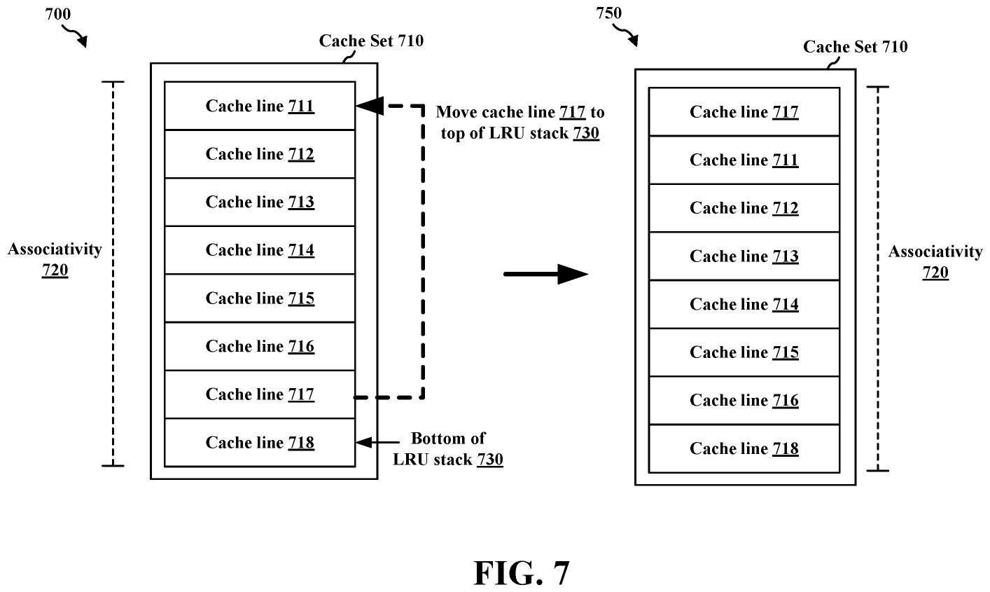

FIG. 7 is a diagram 700 and a diagram 750, respectively, illustrating example cache line replacement for a cache. More specifically, FIG. 7 depicts a cache line replacement for a cache including cache lines in an LRU stack. As shown in FIG. 7. diagram 700 illustrates cache set 710 including a number of cache lines (e.g., cache line 711, cache line 712, cache line 713, cache line 714, cache line 715, cache line 716, cache line 717, and cache line 718) including an associativity 720. The associativity 720 may correspond to the number of cache lines (e.g., cache lines 711-718) that are associated with the cache set 710. FIG. 7 depicts that cache lines 711-718 are included in LRU stack 730 in the cache set 710. For instance, diagram 700 shows that cache line 711 is at the top of the LRU stack 730 and cache line 718 is at the bottom of the LRU stack 730. As depicted in diagram 700, the cache line replacement determines that cache line 717 may be moved to the top of the LRU stack 730. Once cache line 717 is moved to the top of the LRU stack 730, diagram 750 displays the result of this cache line replacement. For instance, cache line 717 is now at the top of the LRU stack 730 and cache line 711 is directly beneath cache line 717 in the LRU stack 730. Cache lines 711-716 are in the previous order in the LRU stack 730, and cache line 718 remains on the bottom of the LRU stack 730. FIG. 7 depicts one example of a biasing LRU cache replacement policy. That is, FIG. 7 depicts that moving an appropriate line (e.g., cache line 717) to the top of LRU stack 730 may bias the cache replacement policy.

Aspects of the present disclosure may utilize a biased cache replacement policy in a number of different GPU systems, such as a single GPU system and a multi-GPU system. In a single GPU system, there may be a three-level cache hierarchy such as a CCHE, a UCHE, and a LLC. When a cache line gets replaced from once cache (e.g., UCHE), aspects presented herein may determine if that cache line exists in another cache (e.g., CCHE), and if so, aspects presented herein may move that cache line to the top of an LRU stack. By doing so, aspects presented herein may provide a second chance to the cache line. Similarly, if a cache line gets replaced from one cache (e.g., LLC), then aspects presented herein may determine if that cache line exists in both other caches (e.g., UCHE and CCHE). Accordingly, aspects presented herein may bring it to the top of the LRU stack in the other caches (e.g., UCHE, CCHE or both), thus giving the line a second chance. This may reduce the overall memory latency at the GPU and thus results in an overall performance improvement.

In a multi-GPU system, aspects presented herein may maintain a particular bit per cache line in all caches. This particular bit, if set, may indicate if the line has been brought originally from a remote cache and was installed in the local cache. While replacing a line from a local cache, in addition to the cache replacement policy such as LRU, aspects presented herein may also determine if the bit is set. If the bit is set, aspects presented herein may not replace that line even though it is on the bottom of the LRU stack, and aspects presented herein may reset the bit and search for the next line up the LRU stack where the bit is not set. Once a line is found where the bit is not set, aspects presented herein may select such a line for replacement. In one case, such as where in a particular set in a local cache all lines are brought from remote cache, aspects presented herein may select the line at bottom of LRU stack for replacement.

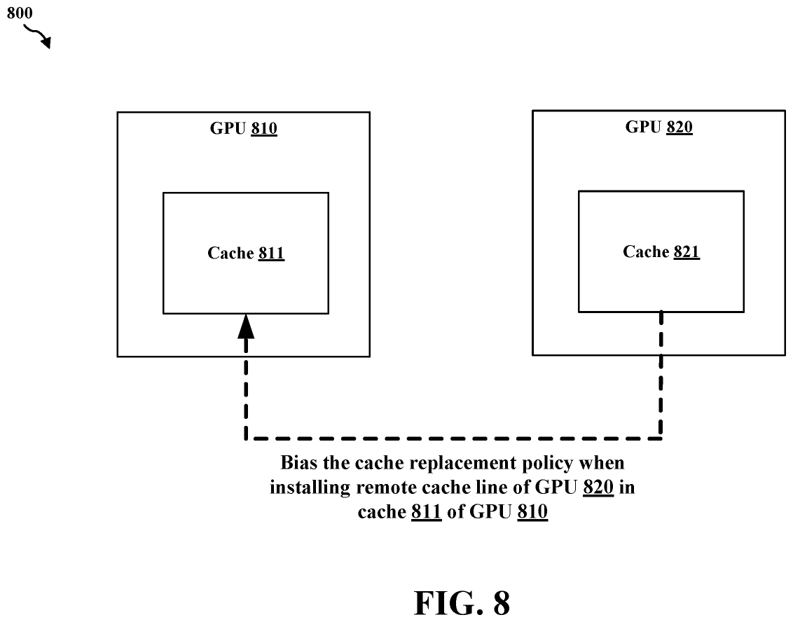

FIG. 8 is a diagram 800 illustrating example cache line replacement for multiple GPUs. More specifically, FIG. 8 depicts a cache line replacement for a multi-GPU system. As shown in FIG. 8, diagram 800 illustrates GPU 810 including cache 811 and GPU 820 including cache 821. FIG. 8 illustrates that aspects presented herein may bias a cache replacement policy when installing a remote cache line. For instance, aspects presented herein may bias the cache replacement policy when installing a remote cache line of GPU 820 in the cache 811 of GPU 810. As shown in FIG. 8, GPUs may maintain a particular bit for each cache line in all caches. This particular bit, if set, may indicate if the line has been brought originally from a remote cache (e.g., cache 821 in GPU 820) and was installed in the local cache (e.g., cache 811 in GPU 810). While replacing a line from a local cache (e.g., cache 811 in GPU 810), in addition to the cache replacement policy such as LRU, the GPUs may also determine if the bit is set. If the bit is set, the GPUs may not replace that line even though it is on the bottom of the LRU stack, and the GPUs may reset the bit and search for the next line up the LRU stack where the bit is not set. Once a line is found where the bit is not set, the GPUs may select such a line for replacement.

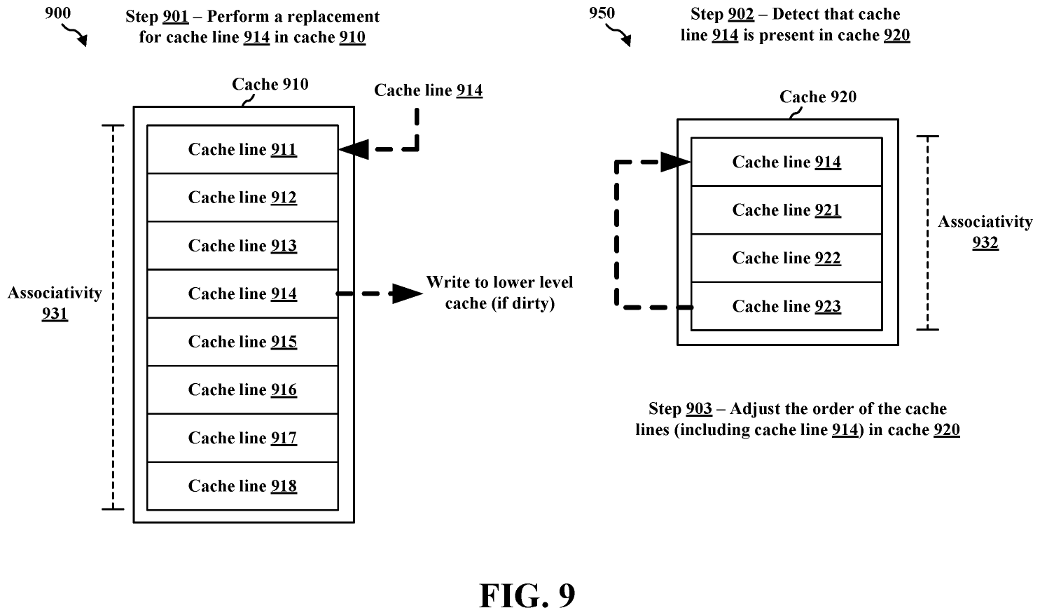

FIG. 9 is a diagram 900 and a diagram 950, respectively, illustrating an example cache line replacement for multiple caches. More specifically, FIG. 9 depicts a cache line replacement for a first cache and a second cache. As shown in FIG. 9, diagram 900 illustrates cache 910 including a number of cache lines (e.g., cache line 911, cache line 912, cache line 913, cache line 914, cache line 915, cache line 916, cache line 917, and cache line 918) including an associativity 931. The associativity 931 may correspond to the number of cache lines (e.g., cache lines 911-918) that are associated with the cache 910. FIG. 9 depicts that cache lines 911-918 are included in an LRU stack in the cache 910. For instance, diagram 900 shows that cache line 911 is at the top of the LRU stack, and cache line 918 is at the bottom of the LRU stack. As depicted in step 901, a cache line replacement is performed, such that cache line 914 may be moved to the top of the LRU stack. For instance, cache line 914 may be written to a lower level cache (e.g., if the data in cache line 914 is dirty). As shown in FIG. 9, the new data that corresponds to cache line 914 may be moved to the top of the LRU stack. Once cache line 914 is moved to the top of the LRU stack as a result of the cache line replacement, cache line 911 will be directly beneath cache line 914 in the LRU stack. Cache lines 911-913 and 915-918 are in the previous order in the LRU stack, and cache line 918 remains on the bottom of the LRU stack. At step 902, diagram 950 shows that cache line 914 is detected to be present in cache 920. As shown in diagram 950, cache 920 includes a number of cache lines (e.g., cache line 914, cache line 921, cache line 922, and cache line 923) including an associativity 932. The associativity 932 may correspond to the number of cache lines that are associated with the cache 920. At step 903, once cache line 914 is detected to be present in cache 920, the order of the cache lines in cache 920 may be adjusted. For example, cache line 914 may be moved to the top of the LRU stack in cache 920. FIG. 9 depicts one example of a biasing LRU cache replacement policy. That is, FIG. 9 depicts that moving an appropriate line (e.g., cache line 914) to the top of LRU stack in cache 920 may bias the cache replacement policy.

As depicted in FIG. 9, aspects presented herein (e.g., a GPU) may perform a replacement for at least one first cache line (e.g., cache line 914) in a first cache (e.g., cache 910). A GPU may also detect that the at least one first cache line (e.g., cache line 914) is present in a second cache (e.g., cache 920). Also, a GPU may adjust, based on the at least one first cache line (e.g., cache line 914) being present in the second cache (e.g., cache 920), an order of a set of first cache lines in the second cache (e.g., cache 920), where the at least one first cache line (e.g., cache line 914) is included in a set of first caches lines in the second cache (e.g., cache 920). In some aspects, adjusting the order of the set of first cache lines in the second cache may include: moving the at least one first cache line (e.g., cache line 914) to a top of a least recently used (LRU) stack at the second cache (e.g., cache 920), where the LRU stack includes the set of first cache lines. Also, moving the at least one first cache line to the top of the LRU stack at the second cache may include: assigning the at least one first cache line (e.g., cache line 914) a higher priority compared to at least one other first cache line in the set of first cache lines in the LRU stack at the second cache (e.g., cache 920). Further, a GPU may output an indication of the adjusted order of the set of first cache lines in the second cache (e.g., cache 920) based on the at least one first cache line (e.g., cache line 914) being present in the second cache (e.g., cache 920).

As mentioned herein, aspects of the present disclosure may improve memory performance and/or average memory latency for caches in GPUs and CPUs. For instance, aspects presented herein may utilize different cache replacement bias in order to optimize the memory performance. For example, aspects presented herein may utilize a cache replacement bias at one cache (e.g., CCHE) for different capacities (e.g., 384 KB and 768 KB capacities) using a two-level cache hierarchy simulator. For example, this two-level cache hierarchy simulator may represent a CCHE and a UCHE, along with a generic DRAM simulator. This cache replacement bias may utilize a number of different caches, such as an L1 cache (e.g., a CCHE), an L2 cache (e.g., a UCHE), and/or an L3 cache (e.g., a last level cache (LLC)). In one example, aspects presented herein may utilize a CCHE biased cache replacement policy with a certain capacity (e.g., 384 KB). In this example, the average memory latency may be improved for certain capacity (e.g., 384 KB) with a certain number of ways (e.g., 4-way, 8-way, or 16-way cache). Further, this average memory latency improvement may be obtained for a small amount of bias. In another example, aspects presented herein may utilize a CCHE biased cache replacement policy with a certain capacity (e.g., 768 KB). In this example, the average memory latency may be improved for certain capacity (e.g., 768 KB) with a certain number of ways (e.g., 2-way, 4-way, 8-way, or 16-way cache). Moreover, this average memory latency improvement may be obtained for a small amount of bias.

Aspects presented herein may include a number of benefits or advantages. Indeed, aspects presented herein may improve memory performance and/or average memory latency for caches in GPUs and CPUs. For instance, aspects of the present disclosure may detect whether certain cache lines are included in different levels of caches. For example, when a cache line in lower-level cache (e.g., a larger cache) is replaced, aspects presented herein may determine if that same line exists in higher-level caches (e.g., faster caches). If a certain cache line is present in a higher-level cache, the GPU or CPU may move such cache lines to the top of a cache line stack (e.g., a least recently used (LRU) stack. By doing so, aspects presented herein may create a bias, as replacing such lines may mean bringing those lines again into the cache, which would entail a larger latency because that line is no longer in the lower-level cache. That is, aspects of the present disclosure may improve memory performance and/or average memory latency for caches in GPUs and CPUs. Moreover, aspects presented herein may determine which cache lines have a high re-fetch cost, as well as keep track of an entire a cache replacement policy. Aspects presented herein also identify whether certain cache lines are included in different levels of caches.

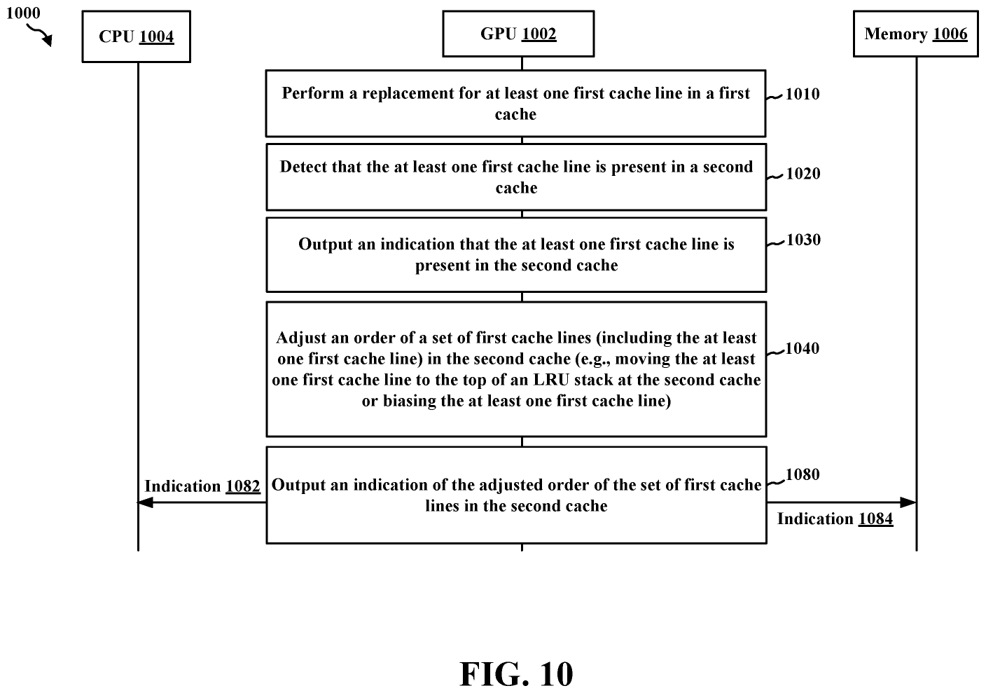

FIG. 10 is a communication flow diagram 1000 of graphics processing in accordance with one or more techniques of this disclosure. As shown in FIG. 10, diagram 1000 includes example communications between GPU 1002 (e.g., a GPU, a GPU component, another graphics processor, a CPU, a CPU component, a DSP, or another central processor), CPU 1004 (e.g., a CPU, a CPU component, another central processor, a GPU, a GPU component, a DSP, or another graphics processor), and memory 1006 (e.g., a system memory, a graphics memory, or a memory or cache at a GPU), in accordance with one or more techniques of this disclosure.

At 1010, GPU 1002 may perform a replacement for at least one first cache line in a first cache.

At 1020, GPU 1002 may detect that the at least one first cache line is present in a second cache. The first cache may include a first storage capacity and the second cache may include a second storage capacity, where the first storage capacity may be larger than the second storage capacity. Also, the first cache may correspond to a first cache level and the second cache may correspond to a second cache level, where the first cache level is a lower cache level compared to the second cache level. The first cache may be a level 2 (L2) cache or a level 3 (L3) cache, and the second cache may be a level 1 (L1) cache or the L2 cache.

At 1030, GPU 1002 may output, to the second cache, a second indication that the at least one first cache line is present in the second cache based on the detection that the at least one first cache line is present in the second cache.

At 1040, GPU 1002 may adjust, based on the at least one first cache line being present in the second cache, an order of a set of first cache lines in the second cache, where the at least one first cache line is included in the set of first cache lines in the second cache. In some aspects, adjusting the order of the set of first cache lines in the second cache may include (e.g., comprise): moving the at least one first cache line to a top of a least recently used (LRU) stack at the second cache, where the LRU stack includes the set of first cache lines. That is, the GPU may move the at least one first cache line to a top of a least recently used (LRU) stack at the second cache, where the LRU stack includes the set of first cache lines. Also, moving the at least one first cache line to the top of the LRU stack at the second cache may include: assigning the at least one first cache line a higher priority compared to at least one other first cache line in the set of first cache lines in the LRU stack. That is, the GPU may assign the at least one first cache line a higher priority compared to at least one other first cache line in the set of first cache lines in the LRU stack. Further, assigning the at least one first cache line the higher priority compared to the at least one other first cache line may include: biasing the at least one first cache line in the LRU stack. That is, the GPU may bias the at least one first cache line in the LRU stack.

In some aspects, the first cache and the second cache may be present in a same graphics processing unit (GPU), and the first cache may be a lower cache level in the same GPU compared to the second cache. In one example, a first cache may be an L2 cache (e.g., a larger, lower level cache) and a second cache may be an L1 cache (e.g., a smaller, higher level cache). A memory access may first check the L1 cache and then, if it is a miss in the L1 cache, it may access the L2 cache. When a line (e.g., line A) is replaced in the first cache (e.g., an L2 cache), aspects presented herein may determine if that line is also present in the second cache (e.g., an L1 cache). If the line is present in the second cache, aspects presented herein may bias the second cache and move that line to the top of the LRU stack (e.g., the LRU stack in the second cache).

In some aspects, to adjust the order of the set of first cache lines in the second cache at 1040, GPU 1002 may move the at least one first cache line to a top of a least recently used (LRU) stack at the second cache based on the at least one first cache line reaching the bottom of the LRU stack. In some aspects, moving the at least one first cache line to the top of the LRU stack at the second cache may include: assigning the at least one first cache line a higher priority compared to at least one other cache line in the set of first cache lines in the LRU stack. That is, the GPU may assign the at least one first cache line a higher priority compared to at least one other cache line in the set of first cache lines in the LRU stack.

At 1080, GPU 1002 may output an indication of the adjusted order of the set of first cache lines in the second cache based on the at least one first cache line being present in the second cache. In some aspects, outputting the indication of the adjusted order of the set of first cache lines may include: transmitting, to a graphics processing unit (GPU) or a central processing unit (CPU), the indication of the adjusted order of the set of first cache lines (e.g., GPU 1002 may transmit indication 1082 to CPU 1004). Also, outputting the indication of the adjusted order of the set of first cache lines may include: storing, in a system memory or a graphics memory, the indication of the adjusted order of the set of first cache lines (e.g., GPU 1002 may store indication 1084 in memory 1006).

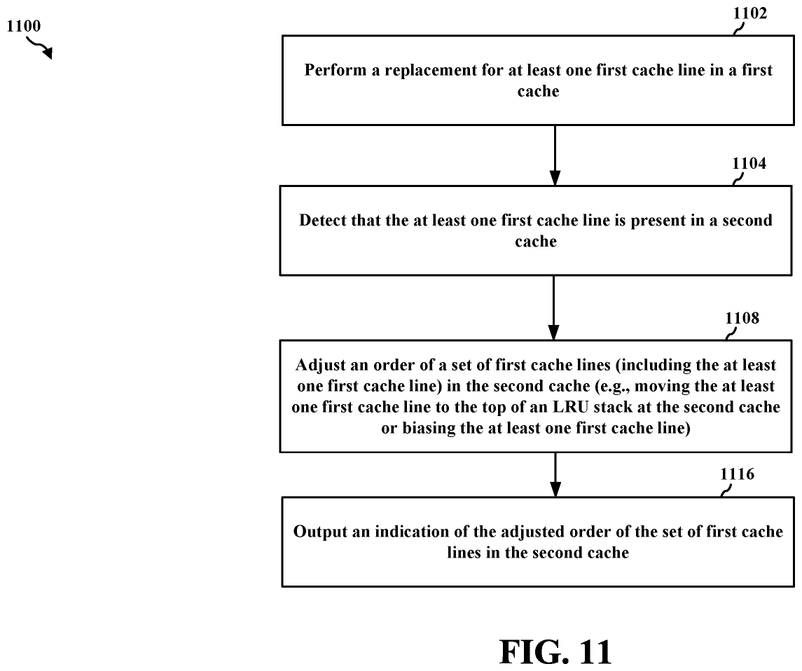

FIG. 11 is a flowchart 1100 of an example method of display processing in accordance with one or more techniques of this disclosure. The method may be performed by a GPU (e.g., a GPU, a GPU component, another graphics processor, a CPU, a CPU component, a DSP, or another central processor), a CPU (a CPU, a CPU component, another central processor, a GPU, a GPU component, a DSP, or another graphics processor), a display driver integrated circuit (DDIC), an apparatus for graphics processing, a wireless communication device, and/or any apparatus that may perform graphics processing as used in connection with the examples of FIGS. 1-10.

At 1102, the GPU may perform a replacement for at least one first cache line in a first cache, as described in connection with the examples in FIGS. 1-10. For example, as described in 1010 of FIG. 10, GPU 1002 may perform a replacement for at least one first cache line in a first cache. Further, step 1102 may be performed by processing unit 120 in FIG. 1.

At 1104, the GPU may detect that the at least one first cache line is present in a second cache, as described in connection with the examples in FIGS. 1-10. For example, as described in 1020 of FIG. 10, GPU 1002 may detect that the at least one first cache line is present in a second cache. Further, step 1104 may be performed by processing unit 120 in FIG. 1. The first cache may include a first storage capacity and the second cache may include a second storage capacity, where the first storage capacity may be larger than the second storage capacity. Also, the first cache may correspond to a first cache level and the second cache may correspond to a second cache level, where the first cache level is a lower cache level compared to the second cache level. The first cache may be a level 2 (L2) cache or a level 3 (L3) cache, and the second cache may be a level 1 (L1) cache or the L2 cache.

At 1108, the GPU may adjust, based on the at least one first cache line being present in the second cache, an order of a set of first cache lines in the second cache, where the at least one first cache line is included in the set of first cache lines in the second cache, as described in connection with the examples in FIGS. 1-10. For example, as described in 1040 of FIG. 10, GPU 1002 may adjust, based on the at least one first cache line being present in the second cache, an order of a set of first cache lines in the second cache, where the at least one first cache line is included in the set of first cache lines in the second cache. Further, step 1108 may be performed by processing unit 120 in FIG. 1. In some aspects, adjusting the order of the set of first cache lines in the second cache may include (e.g., comprise): moving the at least one first cache line to a top of a least recently used (LRU) stack at the second cache, where the LRU stack includes the set of first cache lines. That is, the GPU may move the at least one first cache line to a top of a least recently used (LRU) stack at the second cache, where the LRU stack includes the set of first cache lines. Also, moving the at least one first cache line to the top of the LRU stack at the second cache may include: assigning the at least one first cache line a higher priority compared to at least one other first cache line in the set of first cache lines in the LRU stack. That is, the GPU may assign the at least one first cache line a higher priority compared to at least one other first cache line in the set of first cache lines in the LRU stack. Further, assigning the at least one first cache line the higher priority compared to the at least one other first cache line may include: biasing the at least one first cache line in the LRU stack. That is, the GPU may bias the at least one first cache line in the LRU stack.

In some aspects, the first cache and the second cache may be present in a same graphics processing unit (GPU), and the first cache may be a lower cache level in the same GPU compared to the second cache. Also, the first cache may be present in a first graphics processing unit (GPU) and the second cache may be present in a second GPU, where the first GPU may be different from the second GPU, and the first GPU and the second GPU may be in a multiple GPU (multi-GPU) system. Further, each first cache line in the set of first cache lines may correspond to one bit of a set of first bits in a first tag array at the first GPU, and the at least one first cache line may correspond to at least one first bit in the set of first bits.

At 1116, the GPU may output an indication of the adjusted order of the set of first cache lines in the second cache based on the at least one first cache line being present in the second cache, as described in connection with the examples in FIGS. 1-10. For example, as described in 1080 of FIG. 10, GPU 1002 may output an indication of the adjusted order of the set of first cache lines in the second cache based on the at least one first cache line being present in the second cache. Further, step 1116 may be performed by processing unit 120 in FIG. 1. In some aspects, outputting the indication of the adjusted order of the set of first cache lines may include: transmitting, to a graphics processing unit (GPU) or a central processing unit (CPU), the indication of the adjusted order of the set of first cache lines. Also, outputting the indication of the adjusted order of the set of first cache lines may include: storing, in a system memory or a graphics memory, the indication of the adjusted order of the set of first cache lines.

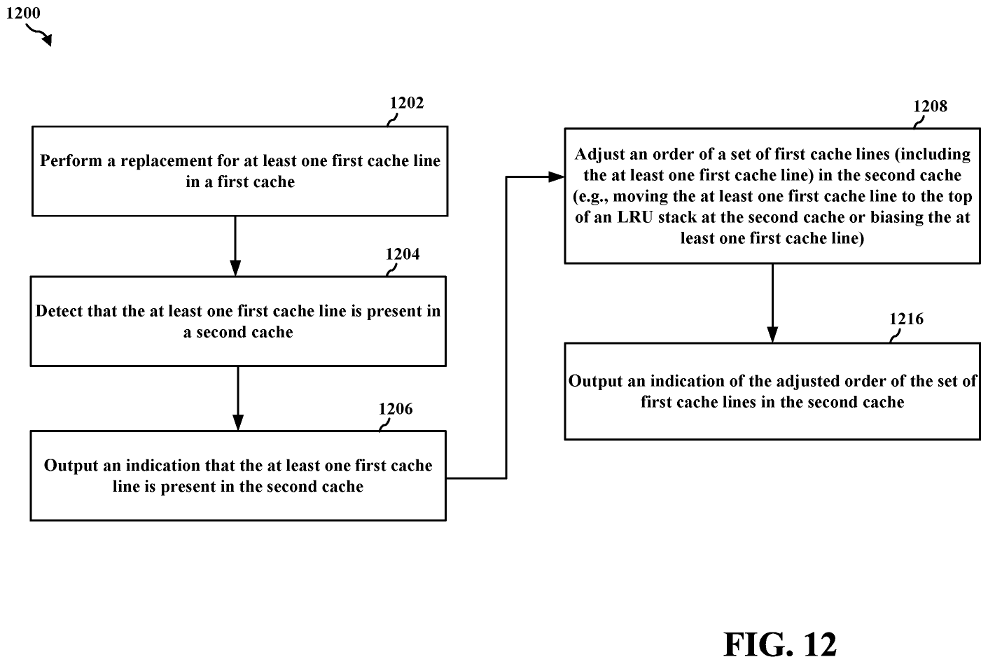

FIG. 12 is a flowchart 1200 of an example method of display processing in accordance with one or more techniques of this disclosure. The method may be performed by a GPU (e.g., a GPU, a GPU component, another graphics processor, a CPU, a CPU component, a DSP, or another central processor), a CPU (a CPU, a CPU component, another central processor, a GPU, a GPU component, a DSP, or another graphics processor), a DDIC, an apparatus for graphics processing, a wireless communication device, and/or any apparatus that may perform graphics processing as used in connection with the examples of FIGS. 1-10.

At 1202, the GPU may perform a replacement for at least one first cache line in a first cache, as described in connection with the examples in FIGS. 1-10. For example, as described in 1010 of FIG. 10, GPU 1002 may perform a replacement for at least one first cache line in a first cache. Further, step 1202 may be performed by processing unit 120 in FIG. 1.

At 1204, the GPU may detect that the at least one first cache line is present in a second cache, as described in connection with the examples in FIGS. 1-10. For example, as described in 1020 of FIG. 10, GPU 1002 may detect that the at least one first cache line is present in a second cache. Further, step 1204 may be performed by processing unit 120 in FIG. 1. The first cache may include a first storage capacity and the second cache may include a second storage capacity, where the first storage capacity may be larger than the second storage capacity. Also, the first cache may correspond to a first cache level and the second cache may correspond to a second cache level, where the first cache level is a lower cache level compared to the second cache level. The first cache may be a level 2 (L2) cache or a level 3 (L3) cache, and the second cache may be a level 1 (L1) cache or the L2 cache.

At 1206, the GPU may output, to the second cache, a second indication that the at least one first cache line is present in the second cache based on the detection that the at least one first cache line is present in the second cache, as described in connection with the examples in FIGS. 1-10. For example, as described in 1030 of FIG. 10, GPU 1002 may output, to the second cache, a second indication that the at least one first cache line is present in the second cache based on the detection that the at least one first cache line is present in the second cache. Further, step 1206 may be performed by processing unit 120 in FIG. 1.

At 1208, the GPU may adjust, based on the at least one first cache line being present in the second cache, an order of a set of first cache lines in the second cache, where the at least one first cache line is included in the set of first cache lines in the second cache, as described in connection with the examples in FIGS. 1-10. For example, as described in 1040 of FIG. 10, GPU 1002 may adjust, based on the at least one first cache line being present in the second cache, an order of a set of first cache lines in the second cache, where the at least one first cache line is included in the set of first cache lines in the second cache. Further, step 1208 may be performed by processing unit 120 in FIG. 1. In some aspects, adjusting the order of the set of first cache lines in the second cache may include (e.g., comprise): moving the at least one first cache line to a top of a least recently used (LRU) stack at the second cache, where the LRU stack includes the set of first cache lines. That is, the GPU may move the at least one first cache line to a top of a least recently used (LRU) stack at the second cache, where the LRU stack includes the set of first cache lines. Also, moving the at least one first cache line to the top of the LRU stack at the second cache may include: assigning the at least one first cache line a higher priority compared to at least one other first cache line in the set of first cache lines in the LRU stack. That is, the GPU may assign the at least one first cache line a higher priority compared to at least one other first cache line in the set of first cache lines in the LRU stack. Further, assigning the at least one first cache line the higher priority compared to the at least one other first cache line may include: biasing the at least one first cache line in the LRU stack. That is, the GPU may bias the at least one first cache line in the LRU stack.

In some aspects, the first cache and the second cache may be present in a same graphics processing unit (GPU), and the first cache may be a lower cache level in the same GPU compared to the second cache. In one example, a first cache may be an L2 cache (e.g., a larger, lower level cache) and a second cache may be an L1 cache (e.g., a smaller, higher level cache). A memory access may first check the L1 cache and then, if it is a miss in the L1 cache, it may access the L2 cache. When a line (e.g., line A) is replaced in the first cache (e.g., an L2 cache), aspects presented herein may determine if that line is also present in the second cache (e.g., an L1 cache). If the line is present in the second cache, aspects presented herein may bias the second cache and move that line to the top of the LRU stack (e.g., the LRU stack in the second cache).

In some aspects, to adjust the order of the set of first cache lines in the second cache at 1208, the GPU may move the at least one first cache line to a top of a least recently used (LRU) stack at the second cache based on the at least one first cache line reaching the bottom of the LRU stack. In some aspects, moving the at least one first cache line to the top of the LRU stack at the second cache may include: assigning the at least one first cache line a higher priority compared to at least one other cache line in the set of first cache lines in the LRU stack. That is, the GPU may assign the at least one first cache line a higher priority compared to at least one other cache line in the set of first cache lines in the LRU stack.

At 1216, the GPU may output an indication of the adjusted order of the set of first cache lines in the second cache based on the at least one first cache line being present in the second cache, as described in connection with the examples in FIGS. 1-10. For example, as described in 1080 of FIG. 10, GPU 1002 may output an indication of the adjusted order of the set of first cache lines in the second cache based on the at least one first cache line being present in the second cache. Further, step 1216 may be performed by processing unit 120 in FIG. 1. In some aspects, outputting the indication of the adjusted order of the set of first cache lines may include: transmitting, to a graphics processing unit (GPU) or a central processing unit (CPU), the indication of the adjusted order of the set of first cache lines. Also, outputting the indication of the adjusted order of the set of first cache lines may include: storing, in a system memory or a graphics memory, the indication of the adjusted order of the set of first cache lines.

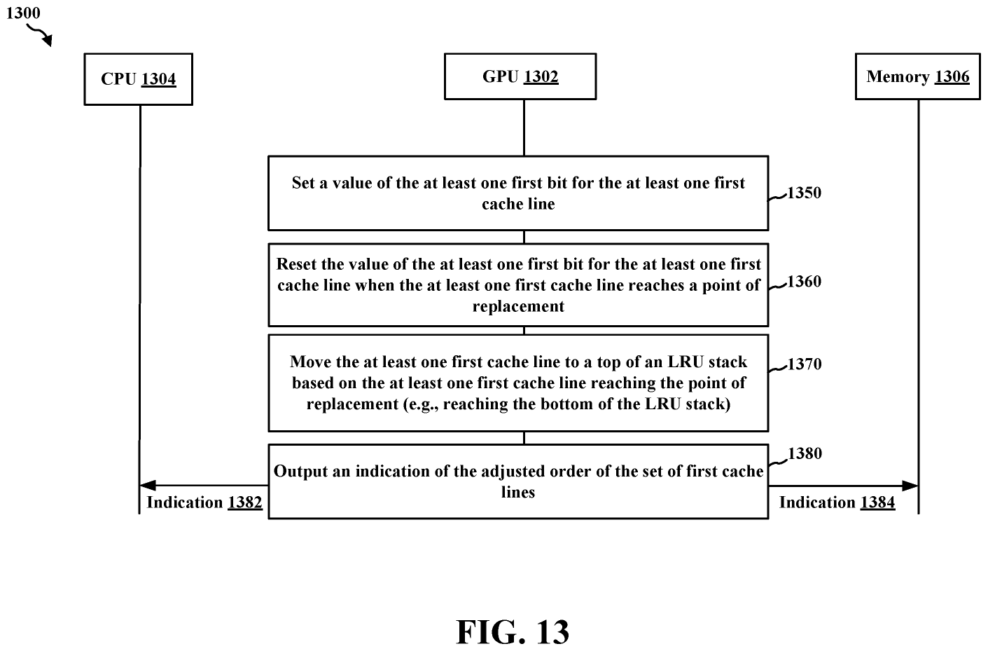

FIG. 13 is a communication flow diagram 1300 of graphics processing in accordance with one or more techniques of this disclosure. As shown in FIG. 13, diagram 1300 includes example communications between GPU 1302 (e.g., a GPU, a GPU component, another graphics processor, a CPU, a CPU component, a DSP, or another central processor), CPU 1304 (e.g., a CPU, a CPU component, another central processor, a GPU, a GPU component, a DSP, or another graphics processor), and memory 1306 (e.g., a system memory, a graphics memory, or a memory or cache at a GPU), in accordance with one or more techniques of this disclosure.

In some aspects, a first cache may be present in a first GPU and a second cache may be present in a second GPU, where the first GPU may be different from the second GPU, and the first GPU and the second GPU may be in a multiple GPU (multi-GPU) system. In one example, a first cache may be a local cache in a local GPU (e.g., GPU0) and a second cache may be a remote cache in a remote GPU (e.g., GPU1). When a line (e.g., line A) is brought from the remote cache in GPU1 to the local cache in GPU0, a bit may be set for that line. In fact, aspects presented herein may maintain an additional bit for each line in the first cache. For remote lines brought into the local cache, the bit may be set to a certain value (e.g., a value of 1). For local lines in the local cache, the bit may be another value (e.g., a value of 0). When a line in the local cache goes to the bottom of an LRU stack, it may be ready for replacement. In such a case, aspects presented herein may determine (i.e., check) if a corresponding bit is set. If the corresponding bit is set, it may be a remote line in the local cache. For such a line, aspects presented herein may reset the bit and move the line from the bottom of the LRU stack to the top of the LRU stack, thus biasing remote lines in the local cache. When that particular remote line goes to the bottom of the LRU stack, as the bit is reset, aspects presented herein may replace the line (e.g., like any other line in the cache). As such, in this example, an extra bit may be utilized for each line in the cache. Additionally, in some aspects, each first cache line in a set of first cache lines (e.g., at a first cache) may correspond to one bit of a set of first bits in a first tag array at the first GPU, and at least one first cache line may correspond to at least one first bit in the set of first bits. Likewise, each second cache line in a set of second cache lines (e.g., at a second cache) may correspond to one bit of a set of second bits in a second tag array at the second GPU, and at least one second cache line may correspond to at least one second bit in the set of second bits.

At 1350, GPU 1302 may set a value of at least one first bit for the at least one first cache line (e.g., a remote cache line). In some aspects, setting the value of the at least one first bit may include: setting the value of the at least one first bit to one (1) based on the at least one first cache line being remote to the first GPU.

At 1360, GPU 1302 may reset the value of the at least one first bit for the at least one first cache line (e.g., a remote cache line) when the at least one first cache line reaches a point of replacement in the first cache (e.g., a local cache). Also, the at least one first cache line may reach the point of replacement when the at least one first cache line reaches a bottom of a least recently used (LRU) stack at the first cache.

At 1370, GPU 1302 may move (i.e., adjust) the at least one first cache line to a top of a least recently used (LRU) stack based on the at least one first cache line reaching the point of replacement (e.g., reaching the bottom of the LRU stack). The LRU stack may be at the first cache (e.g., a local cache). In some aspects, moving (i.e., adjusting) the at least one first cache line to the top of the LRU stack may include: assigning the at least one first cache line a higher priority compared to at least one other cache line in the set of first cache lines in the LRU stack. That is, the GPU may assign the at least one first cache line a higher priority compared to at least one other cache line in the set of first cache lines in the LRU stack (e.g., at the first or local cache).

At 1380, GPU 1302 may output an indication of the adjusted order of the set of first cache lines. In some aspects, outputting the indication of the adjusted order of the set of first cache lines may include: transmitting, to a graphics processing unit (GPU) or a central processing unit (CPU), the indication of the adjusted order of the set of first cache lines (e.g., GPU 1302 may transmit indication 1382 to CPU 1304). Also, outputting the indication of the adjusted order of the set of first cache lines may include: storing, in a system memory or a graphics memory, the indication of the adjusted order of the set of first cache lines (e.g., GPU 1302 may store indication 1384 in memory 1306).

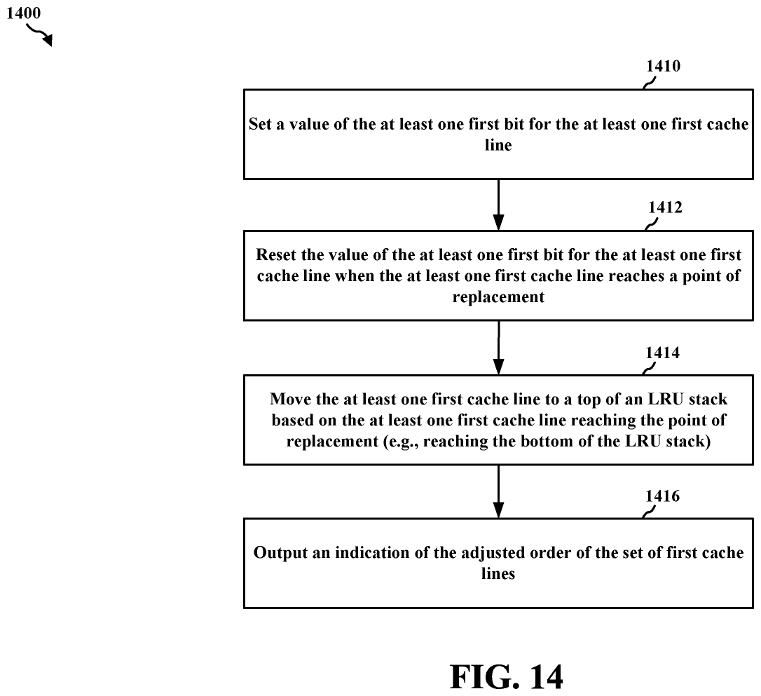

FIG. 14 is a flowchart 1400 of an example method of display processing in accordance with one or more techniques of this disclosure. The method may be performed by a GPU (e.g., a GPU, a GPU component, another graphics processor, a CPU, a CPU component, a DSP, or another central processor), a CPU (a CPU, a CPU component, another central processor, a GPU, a GPU component, a DSP, or another graphics processor), a DDIC, an apparatus for graphics processing, a wireless communication device, and/or any apparatus that may perform graphics processing as used in connection with the examples of FIGS. 1-10.

In some aspects, a first cache may be present in a first GPU and a second cache may be present in a second GPU, where the first GPU may be different from the second GPU, and the first GPU and the second GPU may be in a multiple GPU (multi-GPU) system. In one example, a first cache may be a local cache in a local GPU (e.g., GPU0) and a second cache may be a remote cache in a remote GPU (e.g., GPU1). When a line (e.g., line A) is brought from the remote cache in GPU1 to the local cache in GPU0, a bit may be set for that line. In fact, aspects presented herein may maintain an additional bit for each line in the first cache. For remote lines brought into the local cache, the bit may be set to a certain value (e.g., a value of 1). For local lines in the local cache, the bit may be another value (e.g., a value of 0). When a line in the local cache goes to the bottom of an LRU stack, it may be ready for replacement. In such a case, aspects presented herein may determine (i.e., check) if a corresponding bit is set. If the corresponding bit is set, it may be a remote line in the local cache. For such a line, aspects presented herein may reset the bit and move the line from the bottom of the LRU stack to the top of the LRU stack, thus biasing remote lines in the local cache. When that particular remote line goes to the bottom of the LRU stack, as the bit is reset, aspects presented herein may replace the line (e.g., like any other line in the cache). As such, in this example, an extra bit may be utilized for each line in the cache.

Additionally, in some aspects, each first cache line in a set of first cache lines (e.g., at a first cache) may correspond to one bit of a set of first bits in a first tag array at the first GPU, and at least one first cache line may correspond to at least one first bit in the set of first bits. Likewise, each second cache line in a set of second cache lines (e.g., at a second cache) may correspond to one bit of a set of second bits in a second tag array at the second GPU, and at least one second cache line may correspond to at least one second bit in the set of second bits.

At 1410, the GPU may set a value of at least one first bit for the at least one first cache line (e.g., a remote cache line), as described in connection with the examples in FIGS. 1-9 and 13. For example, as described in 1350 of FIG. 13, GPU 1302 may set a value of at least one first bit for the at least one first cache line. Further, step 1410 may be performed by processing unit 120 in FIG. 1. In some aspects, setting the value of the at least one first bit may include: setting the value of the at least one first bit to one (1) based on the at least one first cache line being remote to the first GPU.

At 1412, the GPU may reset the value of the at least one first bit for the at least one first cache line (e.g., a remote cache line) when the at least one first cache line reaches a point of replacement in the first cache (e.g., a local cache), as described in connection with the examples in FIGS. 1-9 and 13. For example, as described in 1360 of FIG. 13, GPU 1302 may reset the value of the at least one first bit for the at least one first cache line when the at least one first cache line reaches a point of replacement in the first cache. Further, step 1412 may be performed by processing unit 120 in FIG. 1. Also, the at least one first cache line may reach the point of replacement when the at least one first cache line reaches a bottom of a least recently used (LRU) stack at the first cache.

At 1414, the GPU may move (i.e., adjust) the at least one first cache line to a top of a least recently used (LRU) stack based on the at least one first cache line reaching the point of replacement (e.g., reaching the bottom of the LRU stack), as described in connection with the examples in FIGS. 1-9 and 13. For example, as described in 1370 of FIG. 13, GPU 1302 may move (i.e., adjust) the at least one first cache line to a top of a least recently used (LRU) stack based on the at least one first cache line reaching the point of replacement (e.g., reaching the bottom of the LRU stack). Further, step 1414 may be performed by processing unit 120 in FIG. 1. The LRU stack may be at the first cache (e.g., a local cache). In some aspects, moving (i.e., adjusting) the at least one first cache line to the top of the LRU stack may include: assigning the at least one first cache line a higher priority compared to at least one other cache line in the set of first cache lines in the LRU stack. That is, the GPU may assign the at least one first cache line a higher priority compared to at least one other cache line in the set of first cache lines in the LRU stack (e.g., at the first or local cache).

At 1416, the GPU output an indication of the adjusted order of the set of first cache lines, as described in connection with the examples in FIGS. 1-9 and 13. For example, as described in 1380 of FIG. 13, GPU 1302 may output an indication of the adjusted order of the set of first cache lines. Further, step 1416 may be performed by processing unit 120 in FIG. 1. In some aspects, outputting the indication of the adjusted order of the set of first cache lines may include: transmitting, to a graphics processing unit (GPU) or a central processing unit (CPU), the indication of the adjusted order of the set of first cache lines (e.g., GPU 1302 may transmit indication 1382 to CPU 1304). Also, outputting the indication of the adjusted order of the set of first cache lines may include: storing, in a system memory or a graphics memory, the indication of the adjusted order of the set of first cache lines (e.g., GPU 1302 may store indication 1384 in memory 1306).

In configurations, a method or an apparatus for display processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for performing a replacement for at least one first cache line in a first cache. The apparatus, e.g., processing unit 120, may also include means for detecting that the at least one first cache line is present in a second cache. The apparatus, e.g., processing unit 120, may also include means for adjusting, based on the at least one first cache line being present in the second cache, an order of a set of first cache lines in the second cache, where the at least one first cache line is included in the set of first cache lines in the second cache. The apparatus, e.g., processing unit 120, may also include means for outputting an indication of the adjusted order of the set of first cache lines in the second cache based on the at least one first cache line being present in the second cache. The apparatus, e.g., processing unit 120, may also include means for outputting, to the second cache, a second indication that the at least one first cache line is present in the second cache based on the detection that the at least one first cache line is present in the second cache. The apparatus, e.g., processing unit 120, may also include means for setting a value of the at least one first bit for the at least one first cache line. The apparatus, e.g., processing unit 120, may also include means for resetting the value of the at least one first bit for the at least one first cache line when the at least one first cache line reaches a point of replacement in the first cache. The apparatus, e.g., processing unit 120, may also include means for moving the at least one first cache line to a top of the LRU stack at the second cache based on the at least one first cache line reaching the bottom of the LRU stack.

The subject matter described herein may be implemented to realize one or more benefits or advantages. For instance, the described graphics processing techniques may be used by a GPU, a CPU, a central processor, or some other processor that may perform graphics processing to implement the cache replacement described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize cache replacement techniques in order to improve memory bandwidth efficiency and/or increase processing speed at a GPU, a CPU, or a DPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C. B and C. or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including a memory and at least one processor coupled to the memory and, based at least in part on information stored in the memory, the at least one processor is configured to: perform a replacement for at least one first cache line in a first cache; detect that the at least one first cache line is present in a second cache; adjust, based on the at least one first cache line being present in the second cache, an order of a set of first cache lines in the second cache, where the at least one first cache line is included in the set of first cache lines in the second cache; and output an indication of the adjusted order of the set of first cache lines in the second cache based on the at least one first cache line being present in the second cache.

Aspect 2 is the apparatus of aspect 1, where to adjust the order of the set of first cache lines in the second cache, the at least one processor is configured to: move the at least one first cache line to a top of a least recently used (LRU) stack at the second cache, where the LRU stack includes the set of first cache lines.

Aspect 3 is the apparatus of aspect 2, where to move the at least one first cache line to the top of the LRU stack at the second cache, the at least one processor is configured to: assign the at least one first cache line a higher priority compared to at least one other first cache line in the set of first cache lines in the LRU stack.

Aspect 4 is the apparatus of aspect 3, where to assign the at least one first cache line the higher priority compared to the at least one other first cache line, the at least one processor is configured to: bias the at least one first cache line in the LRU stack.

Aspect 5 is the apparatus of any of aspects 1 to 4, where the first cache includes a first storage capacity and the second cache includes a second storage capacity, and where the first storage capacity is larger than the second storage capacity.

Aspect 6 is the apparatus of any of aspects 1 to 5, where the first cache corresponds to a first cache level and the second cache corresponds to a second cache level, and where the first cache level is a lower cache level compared to the second cache level.

Aspect 7 is the apparatus of aspect 6, where the first cache is a level 2 (L2) cache or a level 3 (L3) cache, and where the second cache is a level 1 (L1) cache or the L2 cache.

Aspect 8 is the apparatus of any of aspects 1 to 7, where the at least one processor is further configured to: output, to the second cache, a second indication that the at least one first cache line is present in the second cache based on the detection that the at least one first cache line is present in the second cache.

Aspect 9 is the apparatus of any of aspects 1 to 8, where the first cache and the second cache are present in a same graphics processing unit (GPU), and where the first cache is a lower cache level in the same GPU compared to the second cache.

Aspect 10 is the apparatus of any of aspects 1 to 9, where the first cache is present in a first graphics processing unit (GPU) and the second cache is present in a second GPU, where the first GPU is different from the second GPU, and where the first GPU and the second GPU are in a multiple GPU (multi-GPU) system.

Aspect 11 is the apparatus of aspect 10, where each first cache line in the set of first cache lines corresponds to one bit of a set of first bits in a first tag array at the first GPU, and where the at least one first cache line corresponds to at least one first bit in the set of first bits.

Aspect 12 is the apparatus of any of aspects 10 to 11, where the at least one processor is further configured to: set a value of the at least one first bit for the at least one first cache line (e.g., if the at least one first cache line is a remote line).

Aspect 13 is the apparatus of any of aspects 10 to 12, where to set the value of the at least one first bit, the at least one processor is configured to: set the value of the at least one first bit to one (1) based on the at least one first cache line being remote to the first GPU.

Aspect 14 is the apparatus of any of aspects 10 to 13, where the at least one processor is further configured to: reset the value of the at least one first bit for the at least one first cache line when the at least one first cache line reaches a point of replacement in the first cache.

Aspect 15 is the apparatus of any of aspects 10 to 14, where the at least one first cache line reaches the point of replacement when the at least one first cache line reaches a bottom of a least recently used (LRU) stack at the first cache.

Aspect 16 is the apparatus of any of aspects 10 to 15, where the at least one processor is further configured to: move the at least one first cache line to a top of the LRU stack based on the at least one first cache line reaching the bottom of the LRU stack.

Aspect 17 is the apparatus of any of aspects 10 to 16, where to move the at least one first cache line to the top of the LRU stack, the at least one processor is configured to: assign the at least one first cache line a higher priority compared to at least one other cache line in the set of first cache lines in the LRU stack.

Aspect 18 is the apparatus of any of aspects 1 to 17, where the apparatus is a wireless communication device further including a transceiver coupled to the at least one processor, where to output the indication of the adjusted order of the set of first cache lines, the at least one processor is configured to: transmit, via the transceiver to a graphics processing unit (GPU) or a central processing unit (CPU), the indication of the adjusted order of the set of first cache lines.

Aspect 19 is the apparatus of any of aspects 1 to 18, where to output the indication of the adjusted order of the set of first cache lines, the at least one processor is configured to: store, in a system memory or a graphics memory, the indication of the adjusted order of the set of first cache lines.

Aspect 20 is a method of graphics processing for implementing any of aspects 1 to 19.

Aspect 21 is an apparatus for graphics processing including means for implementing any of aspects 1 to 19.

Aspect 22 is a computer-readable medium (e.g., a non-transitory computer-readable medium) storing computer executable code, the code when executed by at least one processor causes the at least one processor to implement any of aspects 1 to 19.

What is claimed is:

1. An apparatus for graphics processing, comprising:
a memory; and
at least one processor coupled to the memory and, based at least in part on information stored in the memory, the at least one processor is configured to:
perform a replacement for at least one first cache line in a first cache;
detect that the at least one first cache line is present in a second cache;
adjust, based on the at least one first cache line being present in the second cache, an order of a set of first cache lines in the second cache, wherein the at least one first cache line is included in the set of first cache lines in the second cache; and
output an indication of the adjusted order of the set of first cache lines in the second cache based on the at least one first cache line being present in the second cache.

2. The apparatus of claim 1, wherein to adjust the order of the set of first cache lines in the second cache, the at least one processor is configured to: move the at least one first cache line to a top of a least recently used (LRU) stack at the second cache, wherein the LRU stack includes the set of first cache lines.

3. The apparatus of claim 2, wherein to move the at least one first cache line to the top of the LRU stack at the second cache, the at least one processor is configured to: assign the at least one first cache line a higher priority compared to at least one other first cache line in the set of first cache lines in the LRU stack.

4. The apparatus of claim 3, wherein to assign the at least one first cache line the higher priority compared to the at least one other first cache line, the at least one processor is configured to: bias the at least one first cache line in the LRU stack.

5. The apparatus of claim 1, wherein the first cache includes a first storage capacity and the second cache includes a second storage capacity, and wherein the first storage capacity is larger than the second storage capacity.

6. The apparatus of claim 1, wherein the first cache corresponds to a first cache level and the second cache corresponds to a second cache level, and wherein the first cache level is a lower cache level compared to the second cache level.

7. The apparatus of claim 6, wherein the first cache is a level 2 (L2) cache or a level 3 (L3) cache, and wherein the second cache is a level 1 (L1) cache or the L2 cache.

8. The apparatus of claim 1, wherein the at least one processor is further configured to:
output, to the second cache, a second indication that the at least one first cache line is present in the second cache based on the detection that the at least one first cache line is present in the second cache.

9. The apparatus of claim 1, wherein the first cache and the second cache are present in a same graphics processing unit (GPU), and wherein the first cache is a lower cache level in the same GPU compared to the second cache.

10. The apparatus of claim 1, wherein the first cache is present in a first graphics processing unit (GPU) and the second cache is present in a second GPU, wherein the first GPU is different from the second GPU, and wherein the first GPU and the second GPU are in a multiple GPU (multi-GPU) system.

11. The apparatus of claim 10, wherein each first cache line in the set of first cache lines corresponds to one bit of a set of first bits in a first tag array at the first GPU, and wherein the at least one first cache line corresponds to at least one first bit in the set of first bits.

12. The apparatus of claim 11, wherein the at least one processor is further configured to:
set a value of the at least one first bit for the at least one first cache line.

13. The apparatus of claim 12, wherein to set the value of the at least one first bit, the at least one processor is configured to: set the value of the at least one first bit to one (1) based on the at least one first cache line being remote to the first GPU.

14. The apparatus of claim 12, wherein the at least one processor is further configured to:
reset the value of the at least one first bit for the at least one first cache line when the at least one first cache line reaches a point of replacement in the first cache.

15. The apparatus of claim 14, wherein the at least one first cache line reaches the point of replacement when the at least one first cache line reaches a bottom of a least recently used (LRU) stack at the first cache.

16. The apparatus of claim 15, wherein the at least one processor is further configured to:
move the at least one first cache line to a top of the LRU stack based on the at least one first cache line reaching the bottom of the LRU stack.

17. The apparatus of claim 16, wherein to move the at least one first cache line to the top of the LRU stack, the at least one processor is configured to: assign the at least one first cache line a higher priority compared to at least one other cache line in the set of first cache lines in the LRU stack.

18. The apparatus of claim 1, wherein the apparatus is a wireless communication device further comprising a transceiver coupled to the at least one processor, wherein to output the indication of the adjusted order of the set of first cache lines, the at least one processor is configured to: transmit, via the transceiver to a graphics processing unit (GPU) or a central processing unit (CPU), the indication of the adjusted order of the set of first cache lines.

19. The apparatus of claim 1, wherein to output the indication of the adjusted order of the set of first cache lines, the at least one processor is configured to: store, in a system memory or a graphics memory, the indication of the adjusted order of the set of first cache lines.

20. A method of graphics processing, comprising:
performing a replacement for at least one first cache line in a first cache;
detecting that the at least one first cache line is present in a second cache;
adjusting, based on the at least one first cache line being present in the second cache, an order of a set of first cache lines in the second cache, wherein the at least one first cache line is included in the set of first cache lines in the second cache; and
outputting an indication of the adjusted order of the set of first cache lines in the second cache based on the at least one first cache line being present in the second cache.

21. The method of claim 20, wherein adjusting the order of the set of first cache lines in the second cache comprises: moving the at least one first cache line to a top of a least recently used (LRU) stack at the second cache, wherein the LRU stack includes the set of first cache lines.

22. The method of claim 21, wherein moving the at least one first cache line to the top of the LRU stack at the second cache comprises: assigning the at least one first cache line a higher priority compared to at least one other first cache line in the set of first cache lines in the LRU stack.

23. The method of claim 22, wherein assigning the at least one first cache line the higher priority compared to the at least one other first cache line comprises: biasing the at least one first cache line in the LRU stack.

24. The method of claim 20, wherein the first cache includes a first storage capacity and the second cache includes a second storage capacity, wherein the first storage capacity is larger than the second storage capacity.

25. The method of claim 20, wherein the first cache corresponds to a first cache level and the second cache corresponds to a second cache level, wherein the first cache level is a lower cache level compared to the second cache level, wherein the first cache is a level 2 (L2) cache or a level 3 (L3) cache, and wherein the second cache is a level 1 (L1) cache or the L2 cache.

26. The method of claim 20, further comprising:
outputting, to the second cache, a second indication that the at least one first cache line is present in the second cache based on the detection that the at least one first cache line is present in the second cache.

27. The method of claim 20, wherein the first cache and the second cache are present in a same graphics processing unit (GPU), and wherein the first cache is a lower cache level in the same GPU compared to the second cache.

28. The method of claim 20, wherein the first cache is present in a first graphics processing unit (GPU) and the second cache is present in a second GPU, wherein the first GPU is different from the second GPU, and wherein the first GPU and the second GPU are in a multiple GPU (multi-GPU) system, wherein each first cache line in the set of first cache lines corresponds to one bit of a set of first bits in a first tag array at the first GPU, and wherein the at least one first cache line corresponds to at least one first bit in the set of first bits, further comprising:
setting a value of the at least one first bit for the at least one first cache line if the at least one first cache line is a remote line;
resetting the value of the at least one first bit for the at least one first cache line when the at least one first cache line reaches a point of replacement in the first cache, wherein the at least one first cache line reaches the point of replacement when the at least one first cache line reaches a bottom of a least recently used (LRU) stack at the first cache; and
moving the at least one first cache line to a top of the LRU stack based on the at least one first cache line reaching the bottom of the LRU stack.

29. An apparatus for graphics processing, comprising:
means for performing a replacement for at least one first cache line in a first cache;
means for detecting that the at least one first cache line is present in a second cache;
means for adjusting, based on the at least one first cache line being present in the second cache, an order of a set of first cache lines in the second cache, wherein the at least one first cache line is included in the set of first cache lines in the second cache; and
means for outputting an indication of the adjusted order of the set of first cache lines in the second cache based on the at least one first cache line being present in the second cache.

30. A computer-readable medium storing computer executable code for graphics processing, the code when executed by a processor causes the processor to:
perform a replacement for at least one first cache line in a first cache;
detect that the at least one first cache line is present in a second cache;
adjust, based on the at least one first cache line being present in the second cache, an order of a set of first cache lines in the second cache, wherein the at least one first cache line is included in the set of first cache lines in the second cache; and
output an indication of the adjusted order of the set of first cache lines in the second cache based on the at least one first cache line being present in the second cache.
